(19) United States
(12) Patent Application Publication
(10) Pub. No.: US 2020/0133286 A1
(43) Pub. Date: Apr. 30, 2020

(54) AUTOMATIC POWER SOURCE CHARGING AND SWAPPING SYSTEM FOR AN AUTONOMOUS VEHICLE (AV)

(71) Applicant: Walmart Apollo, LLC, Bentonville, AR (US)

(72) Inventors: Jason Bellar, Bella Vista, AR (US); Jeremy L. Velten, Bella Vista, AR (US); Donald Ray High, Noel, MO (US); Robert Cantrell, Herndon, VA (US); Brian Gerard McHale, Oldham (GB)

(21) Appl. No.: 16/663,922

(22) Filed: Oct. 25, 2019

Related U.S. Application Data
(60) Provisional application No. 62/751,000, filed on Oct. 26, 2018.

(51) Int. Cl. G05D 1/02; B60L 53/80; G05D 1/10; B64C 39/02; B60L 50/75

(52) U.S. Cl. CPC G05D 1/0225; B60L 53/80; G05D 1/101; B60L 2200/10; B60L 50/75; G05D 1/0231; B64C 39/024

(57) ABSTRACT

Systems, methods, and machine readable media are provided for automatic charging and swapping power sources for an Autonomous Vehicle (AV). A determination is made whether a current first power source installed in an AV has sufficient power to complete a task assigned to the AV. In response to determining the first power source has insufficient power to complete the assigned task, the AV is directed to a location of a power source repository. The AV is positioned proximate a power source swapping unit of the power source repository where the first power source is removed from the AV and a second power source stored at the power source repository is installed into the AV.

### RELATED APPLICATIONS

The present application claims priority to and the benefit of U.S. Provisional Application No. 62/751,000, filed on Oct. 26, 2018, the disclosure of which is incorporated by reference herein in its entirety.

### BACKGROUND

Autonomous Vehicles (AVs) may be used within a retail facility to provide several functions. One type of autonomous vehicle is an aerial drone. Another type of autonomous vehicle is an autonomous ground vehicle. Current technology limits for AVs include battery capacity per charge which can limit an operation of the AVs. The flight or drive time of an AV can be dependent on the size of the AV, the weight of the AV, and the weight of payload being transported by the AV as well as other factors. As one example, flight time per charge for aerial drones used in retail environments can typically be approximately fifteen to twenty minutes. As another example, a drive time per charge of an autonomous ground vehicle used in retail environments can typically be approximately three to four hours.

### SUMMARY

In accordance with embodiments of the present disclosure, a system for swapping a power source for an autonomous vehicle (AV) is presented. The system includes an AV configured to autonomously complete tasks, the AV being powered by, e.g., a first power source, such as a first battery. The system also includes a power source repository storing one or more second power sources and including a power source swapping unit to facilitate autonomous power source swapping for the AV. The system further includes a first computing device configured to determine whether a first power source of the AV has sufficient power to complete a task assigned to the AV, and to direct the AV to a location of the power source repository in response to determining the current power source has insufficient power to complete the assigned task. The system positions the AV proximate the power source swapping unit of the power source repository. The AV interacts with the power source swapping unit to enable removal of the first power source (e.g., the first battery) from the AV and installation of the second power source (e.g., a second battery) into the AV.

In accordance with other embodiments of the present disclosure, a computer-implemented method for automatic power source charging and swapping for an AV is disclosed. The method includes determining whether a current first power source installed in an AV has sufficient power to complete a task assigned to (or to be assigned to) the AV. In response to determining the first power source has insufficient power to complete the task, the method includes directing the AV to a location of a power source repository. The method also includes positioning the AV proximate to a power source swapping unit of the power source repository and removing of the first power source from the AV and installing a second power source stored at the power source repository into the AV.

In another embodiment, a non-transitory machine-readable medium stores instructions executable by a computing device, wherein execution of the instructions causes the computing device to implement a method for automatic power source charging and swapping system for an Autonomous Vehicle (AV). The medium includes instructions for determining whether current first power source installed in an AV has sufficient power to complete a task assigned to the AV and directing the AV to a location of a power source repository in response to determining the first power source has insufficient power to complete the assigned task. The medium further includes instructions for positioning the AV proximate to a power source swapping unit of the power source repository, instructions for removing of the first power source from the AV, and instructions for installing a second power source stored at the power source repository into the AV.

### BRIEF DESCRIPTION OF THE DRAWINGS

The accompanying drawings, which are incorporated in and constitute a part of this specification, illustrate one or more embodiments of the present disclosure and, together with the description, help to explain inventive aspects of the present disclosure. The drawings are not necessarily to scale, or inclusive of all elements of a system, emphasis instead generally being placed upon illustrating the concepts, structures, and techniques sought to be protected herein. In the drawings:

FIG. 1A is a block diagram of a system for automatic power source charging and swapping for an autonomous vehicle, according to an example embodiment.

FIG. 1B is a block diagram of a power source swapping unit, according to an example embodiment.

FIG. 1C is a block diagram of another power source swapping unit, according to an example embodiment.

FIG. 1D is a block diagram of another power source swapping unit, according to an example embodiment.

FIG. 2A is a block diagram of an unmanned aerial vehicle (UAV), according to an example embodiment.

FIG. 2B is a block diagram of an autonomous ground vehicle (AGV), according to an example embodiment.

FIG. 3 is a flow diagram for a method of automatic power source charging and swapping for an autonomous vehicle, according to an example embodiment.

FIG. 4 is a diagram of an exemplary network environment suitable for automatic power source charging and swapping for an autonomous vehicle according to an exemplary embodiment.

FIG. 5 is a block diagram of an exemplary computing device that may be used to implement exemplary embodiments described herein.

### DETAILED DESCRIPTION

Systems and methods of the present disclosure can be utilized to charge and swap power sources for an autonomous vehicle (AV). A determination is made whether a first power source of the AV has sufficient power to complete a task assigned to, or to be assigned to, the AV. The AV is directed to a location of a power source repository in response to determining the current power source has insufficient power to complete the task. The system positions the AV proximate a power source swapping unit of the power source repository, and the AV interacts with the power source swapping unit to enable autonomous removal of the first power source from the AV and autonomous installation of the second power source into the AV.

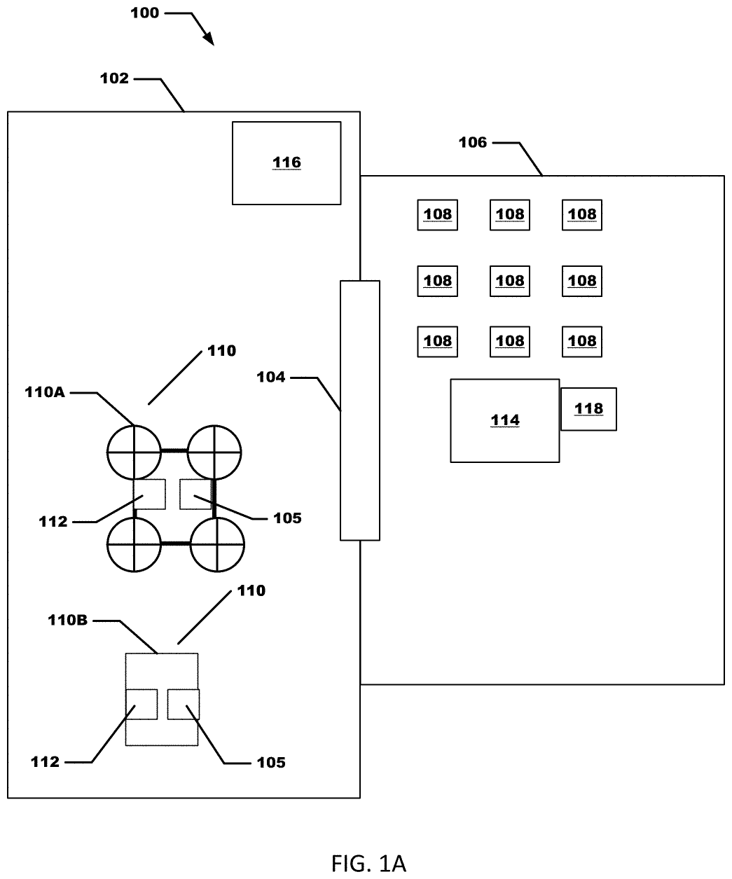

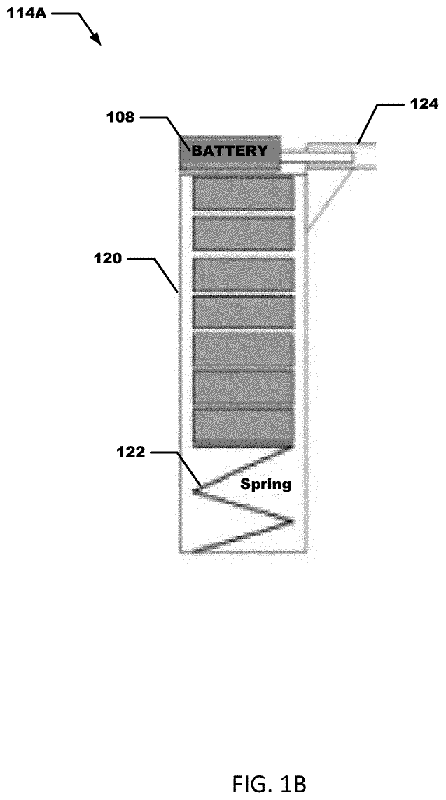

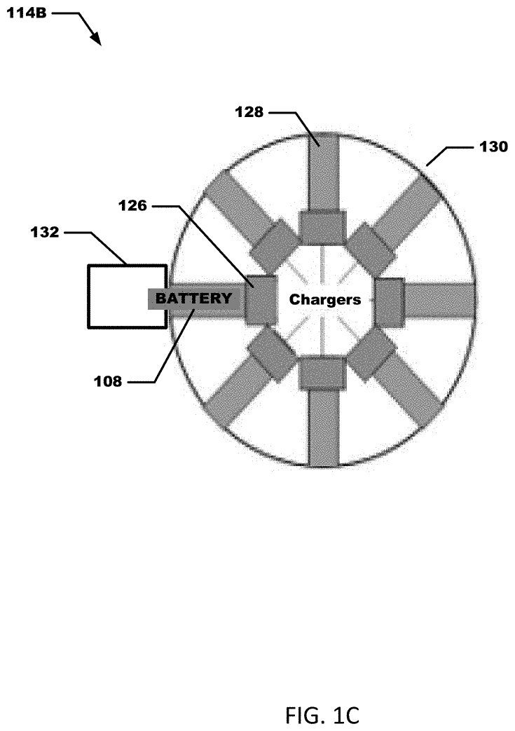

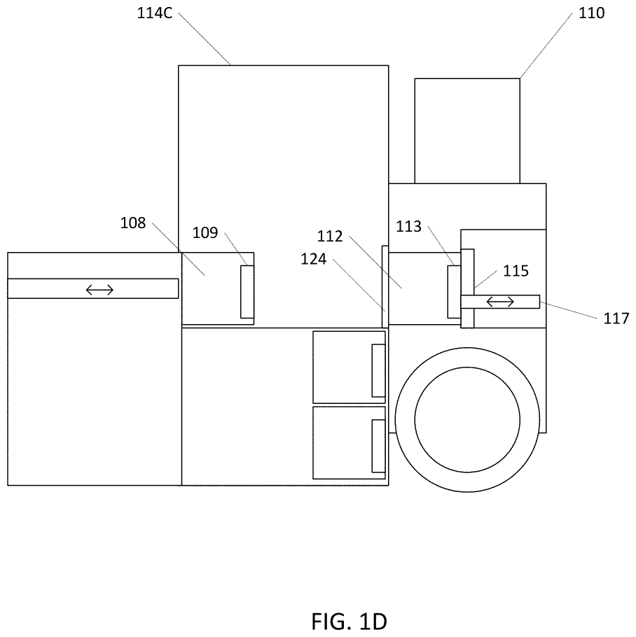

FIG. 1A shows a system 100 for automatic power source charging and swapping for one or more AVs 110 in an example environment, such as a retail facility 102 including a gateway 104. The system 100 includes a power source repository 106 that is accessible by the one or more AVs (e.g., aerial drones, autonomous ground vehicles), collectively denoted as 110, via the gateway 104. The AVs 110 can be tethered or untethered, on rails, or tracks, and/or can freely roam the facility. The power source repository 106 includes replacement power sources 108 and a power source swapping unit 114. Each of the one or more AVs 110 can include a power source 112. Each power source 112 can be mechanically and electrically coupled to each of the one or more AVs 110.

The AVs 110, in this example, can include an aerial autonomous vehicle 110A and/or an autonomous ground vehicle 110B. The AVs 110 can be configured to autonomously complete tasks in response to instructions from a computing system. These tasks can include, for example, scanning inventory, delivering an item from a source location to a destination location, performing cleaning and/or maintenance functions and/or returning an item from a destination location to a source location. The tasks may further include, for example, monitoring tasks, auditing tasks, and/or security tasks. The AVs 110 are each powered by the first power source 112, which may be a battery or a fuel cell. The AVs 110 may include one or more accessories, such as a camera, a sensor, and/or a scanner.

The power source repository 106 stores the replacement power sources 108 and includes a power source swapping unit 114 to facilitate autonomous power source swapping for the AV 110. The replacement power sources 108 can be batteries or fuel cells.

A computing device 116 is shown separate from the AVs 110, although it should be understood that in some embodiments the computing device 116 may be integrated with each of the AVs 110. The computing device 116 determines whether a first power source 112 of the AVs 110 has sufficient power to complete a task assigned to, or to be assigned to, the AVs 110.

The computing device 116 instructs the one or more AVs 110 to navigate to a location of the power source repository 106 in response to determining the current power source has insufficient power to complete the task. The computing device 116 instructs the one or more AVs 110 to position themselves proximate to the power source swapping unit 114 of the power source repository 106. The one or more AVs 110 can use a number of location techniques to accomplish the positioning of the one or more AVs 110 including: optical markings, Radio Frequency (RF) beaconing, indicator lights, Light Emitting Diode (LED) signaling lights, scalable vector graphics (SVG), lidar, sonar, proximity and camera vision, etc. The one or more AVs 110 can program with a map of the facility 100 and/or can generate a map of the facility using simultaneous localization and mapping (SLAM).

The one or more AVs 110 can interact with the power source swapping unit 114 to enable removal of the first power source 112 from the one or more AVs 110 and installation of one of the second power sources 108 into the one or more AVs 110.

In one embodiment, a weight of one of the one or more AVs 110 detected proximate to the power source swapping unit 114 which causes the first power source 112 to be removed and a second power source 108 to be installed. In another embodiment, one of the one or more AVs 110 can be positioned on top of the second power source 108, causing the first power source 112 to be ejected and the second power 108 source to be inserted. In another embodiment, the one or more AVs can be positioned on a dispenser platform of the power source swapping unit 114 wherein the first power source 112 is removed from the one or more AVs 110 and wherein the second power source 108 is installed from a cartridge of the power source swapping unit 114. In another example embodiment, the one or more AVs 110 can be positioned adjacent to the power source swapping unit 114 and a mechanical arm 118 of the power source swapping unit 114 removes the first power source 112 from the one or more AVs 110 and installs one of the second power sources 108 in the one or more AVs 110. In another embodiment, the first power source 112 can be magnetically (or electromagnetically) and electrically coupled to the one or more AVs 110. When the one or more AVs 110 dock on the power source swapping unit 114, the power source can be ejected from the one or more AV 110 either by overcoming the magnetic force, reversing the magnetic force, or ceasing the magnetic force. The second power source 108 can be magnetically (or electromagnetically) and electrically coupled to the one or more AVs 110.

In operation, a selected one of the one or more AVs 110 can receive a task (e.g., from the computing device 116), for example to perform an inventory scan of an aisle of products. The computing device 116 can determine if the current power source 112 of the selected one of the one or more AVs 110 has enough power to complete the task. In the event the determination is that there is enough power for the selected one of the one or more AVs 110 to complete the task, then the task is executed by the selected one of the one or more AVs 110.

When the computing device determines there is not enough remaining power for the selected one of the one or more AVs 110 to complete the task, the selected one of the one or more AVs 110 is directed to swap the current power source 112 with a replacement power source 108 so that the selected one of the one or more AVs 110 can complete the task. This may involve what is termed an “early swap” wherein the current power source 112 is not completely exhausted, but is replaced as it does not have enough power left to complete the task.

In certain embodiments, the one or more AVs 110 can include a backup power source 105 that is used to keep the one or more AVs operational while the power source 112 is being swapped out and/or when the one or more AVs 110 a being stored. For example, the one or more AVs 110 can be stored with the backup power source and when the one or more AVs 110 are assigned a task, the one or more AVs 110 can be powered by the backup power source 105 to navigate to the power source swapping unit 114 to receive the first or second power source 112 or 108, respectively. In some embodiments, the power source 108 and/or 112 can charge the backup power source 105. In some embodiments, the backup power source can run minimal life support for the one or more AVs 110. The power sources 112 and 108 can be hydrogen or propane fuel cell, a battery or a combination of a fuel cell and battery. The power source installed on the one or more AVs 110 (e.g., power source 112 or 108) can be electronically and/or mechanically locked and unlocked from the one or more AVs 110.

Typically in retail facilities, a firewall exists between the retail floor and the back room. The one or more AVs 110 can navigate through a hinged or sliding door or window in the firewall. Various techniques could be used to signal the door/window to open, including: radio, IR light, LED door sensors, RF sensors, etc. Additionally, the computing device 116 may signal the door or window to open upon determination that one of the AVs 110 is proximate to the door or window, without direct communication between the AVs 110 and the door or window.

FIG. 1B is a block diagram of a power source swapping unit 114a. The power source swapping unit 114a includes a base 120 having one or more batteries 108. The batteries 108 are arranged in a stacked configuration within base 120 with a spring 122 providing upward bias to the batteries 108. The power source swapping unit 114a also includes a docking interface 124 which allows an AV to couple to or interface with the power source swapping unit 114a and install a replacement battery 108 into the AV. In some embodiments the power source swapping unit 114 can further include a charger (not shown) for the batteries 108.

FIG. 1C is a block diagram of a power source swapping unit 114b. The power source swapping unit 114b includes a rotatable battery charging magazine 130. The magazine 130 includes a group of slots 128 capable of storing a battery 108 therein. Also shown is a charger 126 for each slot 128. The power source swapping unit 114b also includes a docking interface 132 which allows an AV to couple to or interface with the power source swapping unit 114b and install a replacement batter 108 into the AV.

FIG. 1D is a block diagram of a power source swapping unit 114C. The power source swapping unit 114C includes a bank of second batteries 108. The one or more AVs 110 can dock at the docking interface 124 of the power source swapping unit at the docking interface 124 of the power source swapping unit 114C. Once the one or more AVs 110 are docked, the one or more AVs 110 can eject the first power source 112 into the power source swapping unit 114C and can receive one of the second power sources 108. In exemplary embodiments, the power sources 108 and 112 can include a magnet or a ferromagnetic material 109 and 113, respectively. The one or more AVs 110 can include a magnet, electromagnet or ferromagnetic material 115 to mechanically couple the power source 112 to the one or more AVs 110. The power source 112 can be released by the one or more AVs by an ejector 117 for embodiments including the magnet or ferromagnetic material. For embodiments that include the electromagnet, the one or more AVs 110 can cease electric current to the electromagnet to release the power source 112.

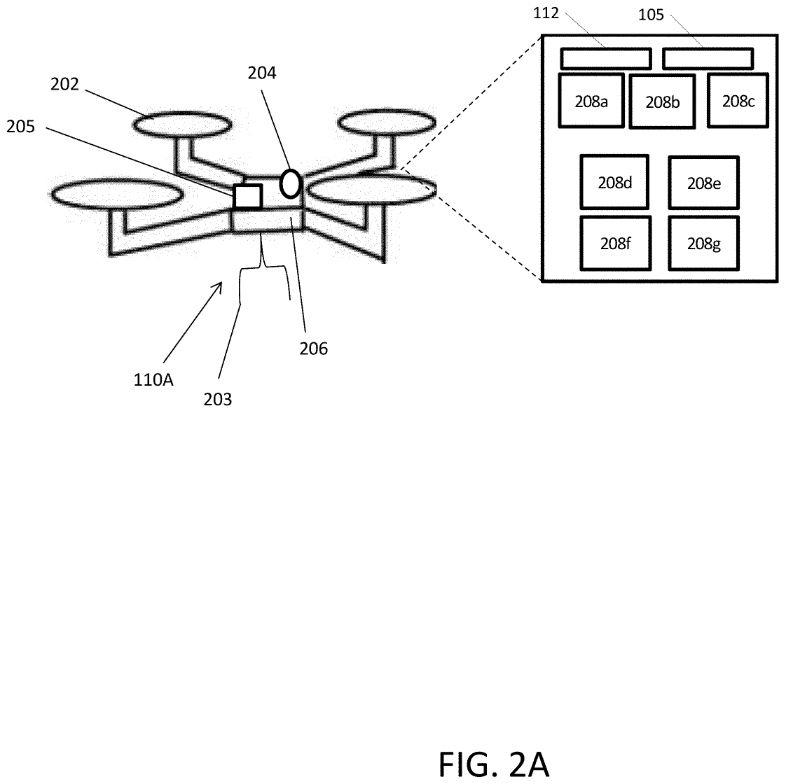

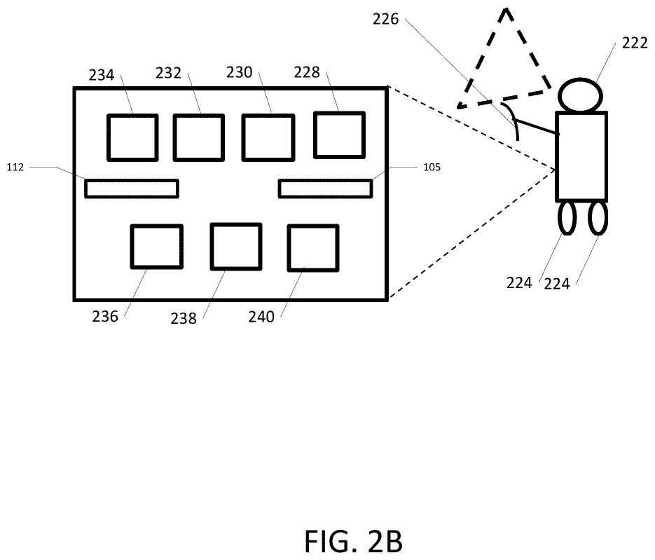

FIG. 2A depicts a diagram illustrating an embodiment of the unmanned aerial vehicle (UAV) 110A. The UAV 110A can autonomously navigate aerially using motive assemblies 202. The motive assemblies 202 can be, but are not limited to, rotors or rotors with blades. The UAV 110A can include a body 206 attached to the motive assemblies 202. As an example, the motive assemblies 202 can be secured to the body 206 on the edges of the UAV 110A. The UAV 110A can also include a sensor 204. The sensor can be one or more of an image sensor, optical reader, motion sensor, temperature sensor, and/or an infrared sensor. As a non-limiting example, the sensor 204 can be disposed on the body 206 of the UAV 110A. The UAV 110A can further include an image capturing device 205. The image capturing device 205 can capture still or moving images while the UAV 110A is stationary or in flight.

The body 206 of the UAV 110A can include a picking unit 203. The picking unit 203 can be one or more of electrically operated clamps, claw-type clips, hooks, electro-magnets or other types of grasping mechanisms. The UAV 110A can include a controller 208a, and an inertial navigation system can include a GPS receiver 208b, accelerometer 208c and a gyroscope 208d. The UAV 110A can also include a drive motor 208e. The controller 208a can be programmed to control the operation of the sensors 204, image capturing device 205, GPS receiver 208b, accelerometer 208c, a gyroscope 208d, drive motor 208e, and motive assemblies 202 (e.g., via the drive motor 208e), in response to various inputs including inputs from the GPS receiver 208b, the accelerometer 208c, and the gyroscope 208d. The drive motor 208e can control the operation of the motive assemblies 202 directly and/or through one or more drive trains (e.g., gear assemblies and/or belts).

The GPS receiver 208b can be an L-band radio processor capable of solving the navigation equations in order to determine a position of the UAV 110A, determine a velocity and precise time (PVT) by processing the signal broadcasted by GPS satellites. The accelerometer 208c and gyroscope 208d can determine the direction, orientation, position, acceleration, velocity, tilt, pitch, yaw, and roll of the UAV 110A. In exemplary embodiments, the controller can implement one or more algorithms, such as a Kalman filter, for determining a position of the UAV 110A.

In one embodiment, the UAV 110A may be further equipped with a communication interface (e.g., one or more transceivers) 208f enabling short or long range communication with a computing device (e.g., the computing device 116). For example, as a non-limiting example, the UAV 110A may be capable of communicating over either or both of a Bluetooth® or Wi-Fi communication link to the computing device.

The UAV 110A can further include the first power source 112 to power the motive assemblies 202, the sensors 204, the image capturing device 205, the controller 208a, the GPS receiver 208b, the accelerometer 208c, the gyroscope 208d, and drive motor 208e. It can be appreciated that the UAV 110A can be configured to conserve battery power based on use of the he motive assemblies 202, the sensors 204, the image capturing device 205, the controller 208a, the GPS receiver 208b, the accelerometer 208c, the gyroscope 208d, and drive motor 208e. The UAV 110A can include the back-up power source 105 that is used to keep the UAV 110A operational while the power source 112 is being swapped out and/or when the UAV 110A a being stored.

FIG. 2B is a block diagram illustrating an embodiment of the AGV 110B in a facility according to exemplary embodiments of the present disclosure. The AGV 110B can be a driverless vehicle, a robot, and/or the like. Embodiments of the AGV 110B can include an image capturing device 222, motive assemblies 224, a picking unit 226, a controller 228, an optical scanner 230, a drive motor 232, a GPS receiver 234, accelerometer 236 and a gyroscope 238, and can be configured to roam autonomously through the facility. The picking unit 226 can be an articulated arm. The AGV 110B can be an intelligent device capable of performing tasks without human control. The controller 228 can be programmed to control an operation of the image capturing device 222, the optical scanner 230, the drive motor 232, the motive assemblies 224 (e.g., via the drive motor 232), in response to various inputs including inputs from the image capturing device 222, the optical scanner 230, the GPS receiver 234, the accelerometer 236, and the gyroscope 238. The drive motor 232 can control the operation of the motive assemblies 224 directly and/or through one or more drive trains (e.g., gear assemblies and/or belts). In this non-limiting example, the motive assemblies 224 are wheels affixed to the bottom end of the AGV 110B. The motive assemblies 224 can be but are not limited to wheels and/or tracks. The motive assemblies 224 can facilitate 360 degree movement for the AGV 110B. The image capturing device 222 can be a still image camera or a moving image camera.

The GPS receiver 234 can be an L-band radio processor capable of solving the navigation equations in order to determine a position of the AGV 110B, determine a velocity and precise time (PVT) by processing the signal broadcasted by GPS satellites. The accelerometer 236 and gyroscope 238 can determine the direction, orientation, position, acceleration, velocity, tilt, pitch, yaw, and roll of the AGV 110B. In exemplary embodiments, the controller can implement one or more algorithms, such as a Kalman filter, for determining a position of the autonomous robot device.

The AGV 110B can receive instructions to scan inventory, deliver an item from a source location to a destination location, return an item from a destination location to a source location, monitor tasks, audit tasks, perform cleaning and/or maintenance, and conduct security tasks.

The AGV 110B can navigate through the facility using the motive assemblies 124 and can be programmed with a map of the facility and/or can generate a map of the first facility using simultaneous localization and mapping (SLAM). The AGV 110B can navigate around the facility based on inputs from the GPS receiver 228, the accelerometer 230, the gyroscope 232, and/or by a programmed path.

The AGV 110B can further include the first power source 112 to power the components of the AGV 110B. It can be appreciated that the AGV 110B can be configured to conserve battery power. The AGV 110B can include the back-up power source 105 that is used to keep the AGV 110B operational while the power source 112 is being swapped out and/or when the AGV 110B a being stored.

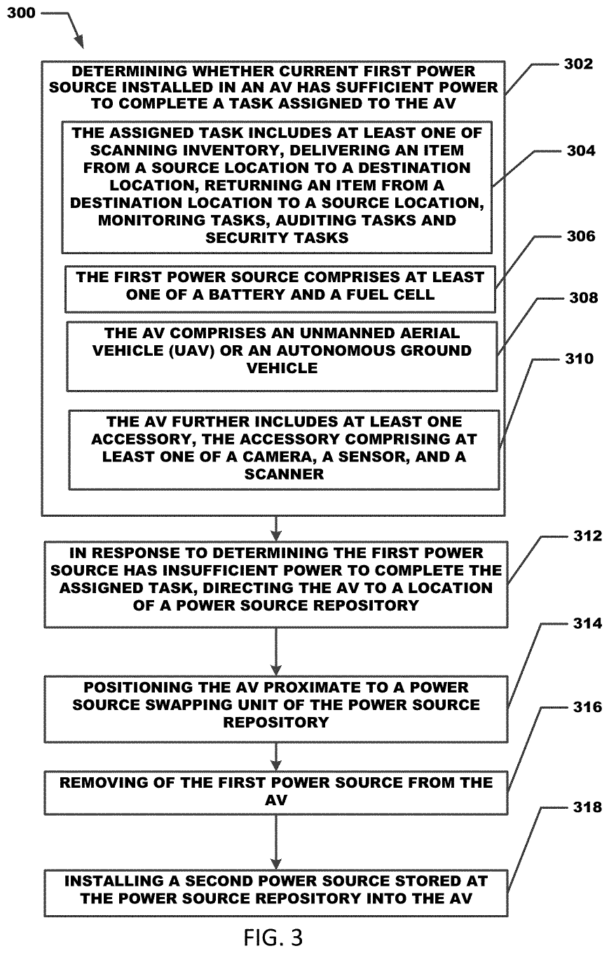

Referring now to FIG. 3, a flow diagram of an example embodiment of a method 300 for an automatic power source charging and swapping for an AV is shown. Method 300 begins with processing block 302 in which instructions are executed by, e.g., a computing device, to determine whether a current first power source installed in an AV has sufficient power to complete a task assigned to, or to be assigned to, the AV. In processing block 304, the task can include at least one of scanning inventory, delivering an item from a source location to a destination location, returning an item from a destination location to a source location, monitoring tasks, auditing tasks and security tasks. In processing block 306, the first power source is shown as comprising at least one of a battery or a fuel cell. The fuel cell may be a hydrogen fuel cell or a propane fuel cell. In processing block 308, the AV is shown as comprising an unmanned aerial vehicle (UAV) or an autonomous ground vehicle (AGV). In processing block 310, the AV is shown as including at least one accessory. The accessory can include a camera, a sensor, and/or a scanner. The accessory may be powered by a battery, whether the power source for the AV may be a separate battery, a fuel cell or a combination.

In processing block 312, the AV is instructed to navigate to a location of a power source repository by the computing device in response to determining the first power source has insufficient power to complete the task. The power source repository can be located in a back room of the retail facility and can include one or more replacement power sources for the AV, as well as a power source swapping unit used to facilitate replacing the current power source with a replacement power source.

In processing block 314, the AV positions itself proximate to a power source swapping unit of the power source repository. In processing block 316, the first power source is removed from the AV by way of the power source swapping unit. In processing block 318, a second power source stored at the power source repository is installed into the AV, also by way of the power source swapping unit. The power sources can be swapped by the power swapping unit using one or more techniques. For example, a weight of the AV being detected proximate to the power source swapping unit causes the first power source to be removed and the second power source to be installed. As another example, the AV can be positioned on top of the second power source, causing the first power source to be ejected and the second power source to be inserted. As another example, the AV can be positioned on a dispenser platform of the power source swapping unit wherein the first power source is removed from the AV and wherein the second power source is installed from a cartridge of the power source swapping unit. As another example, the AV can be positioned adjacent the power source swapping unit, wherein a mechanical arm of the power source swapping unit removes the first power source from the AV and installs the second power source in the AV.

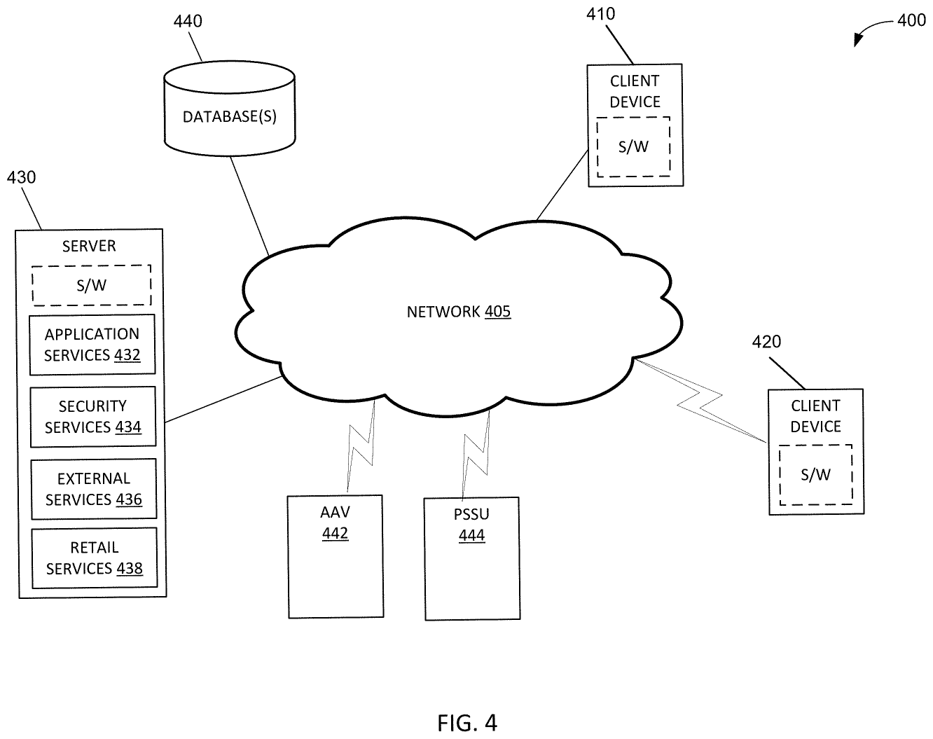

FIG. 4 illustrates a network diagram depicting an embodiment of the system 100 for automatic power source charging and swapping for an AV 342 according to an example embodiment. The system 100 can include a network 405, multiple client devices, for example, client device 410, client device 420, a server 430, and database(s) 440. Each of the client devices 410, 420, server 430, and database(s) 440 is in communication with the network 405.

In an example embodiment, one or more portions of network 405 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMax network, another type of network, or a combination of two or more such networks.

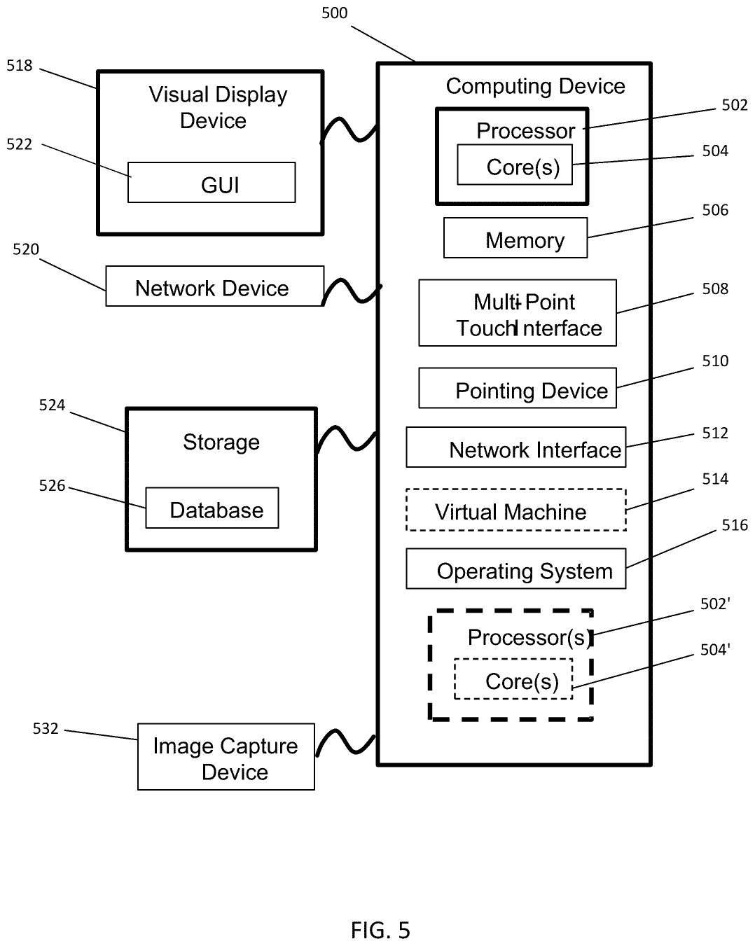

The client devices 410, 420 may comprise, but are not limited to, mobile devices, handheld devices, wireless devices, portable devices, wearable computers, cellular or mobile phones, portable digital assistants (PDAs), smart phones, smart watches, tablets, ultrabooks, netbooks, laptops, desktops, multi-processor systems, microprocessor-based or programmable consumer electronics, and the like. Each of client devices 410, 420 may connect to network 405 via a wired or wireless connection. In an example embodiment, the client devices 410, 420 may perform one or more of the functionalities of the system 100 for automatic power source charging and swapping for an AV described herein, or transmit data or signals to the system 100 described herein. The client device 410, 420 can include one or more components of computing device 500 of FIG. 5.

In an example embodiment, executable code/instructions for implementing the system for automatic power source charging and swapping for an AV may be included at least in part on the client device 410, 420, and the client device 410, 420 can perform one or more of the functionalities/processes of the system described herein. In an example embodiment, the executable code/instructions for implementing the system 100 may be included at least in part on the server 430, and the server 430 can perform one or more of the functionalities/processes of the system 100 described herein.

The database(s) 440 comprises one or more storage devices for storing data and/or instructions (or code) for use by the server 430 and/or the client devices 410, 420. Each of the database(s) 440 and the server 430 is connected to the network 405 via a wired connection. Alternatively, one or more of the database(s) 440 and server 430 may be connected to the network 405 via a wireless connection. The server 430 comprises one or more computers or processors configured to communicate with the client devices 410, 420 via network 405. The server 430 can include one or more components of device 500 of FIG. 5. Server 430 hosts one or more software systems, applications or websites, including one or more components of the system 100 described herein and/or facilitates access to the content of database(s) 440.

Database(s) 440 and server 430 may be located at one or more geographically distributed locations from each other or from client devices 410, 420. Alternatively, database(s) 440, 445 may be included within server 430. Also shown is AV 442 and power source swapping unit 444. The power source swapping unit 444 used to facilitate replacing the current power source with a replacement power source. The AV 442 can be configured to autonomously complete tasks in response to instructions from the server 430 or client devices 410, 420. The AV 442 is powered by a power source.

FIG. 5 is a block diagram of an exemplary computing device 500 that can be used to perform one or more steps of the methods/processes provided by exemplary embodiments. For example, computing device 500 may be the client device 410, 420 and the server 430 as described in FIG. 4. The computing device 500 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flash drives), and the like. For example, memory 506 included in the computing device 500 can store computer-readable and computer-executable instructions or software for implementing exemplary embodiments. The computing device 500 also includes a configurable and/or programmable processor 502 and associated core 504, and optionally, one or more additional processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ can each be a single core processor or multiple core (504 and 504′) processor.

Virtualization can be employed in the computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can include a computer system memory or random access memory, such as DRAM, SRAM, EDO RAM, and the like. Memory 506 can include other types of memory as well, or combinations thereof. An individual can interact with the computing device 500 through a visual display device 518, such as a touch screen display or computer monitor, which can display one or more user interfaces 522 for receiving data from the individual (e.g., order data and travel data). The visual display device 518 can also display other aspects, elements and/or information or data associated with exemplary embodiments. The computing device 500 can include other I/O devices for receiving input from an individual, for example, a keyboard or another suitable multi-point touch interface 508, a pointing device 510 (e.g., a pen, stylus, mouse, or trackpad). The keyboard 508 and the pointing device 510 can be coupled to the visual display device 518. The computing device 500 can include other suitable I/O peripherals.

The computing device 500 can also include one or more storage devices 524, such as a hard-drive, CD-ROM, or other computer readable media, for storing data and computer-readable instructions and/or software, such as one or more modules for implementing an embodiment of the system 100 that implements exemplary embodiments of the system as described herein, or portions thereof, which can be executed to facilitate charging and autonomous swapping of power sources on AVs. Exemplary storage device 524 can also store one or more databases for storing suitable information required to implement exemplary embodiments. The databases can be updated by an individual or automatically at a suitable time to add, delete or update one or more items in the databases. Exemplary storage device 524 can store one or more databases 526 for storing provisioned data, and other data/information used to implement exemplary embodiments of the systems and methods described herein.

The computing device 500 can include a network interface 512 configured to interface via one or more network devices 522 with one or more networks, for example, Local Area Network (LAN), Wide Area Network (WAN) or the Internet through a variety of connections including, but not limited to, standard telephone lines, LAN or WAN links (for example, 802.11, T1, T3, 46 kb, X.25), broadband connections (for example, ISDN, Frame Relay, ATM), wireless connections, controller area network (CAN), or some combination of any or all of the above. The network interface 512 can include a built-in network adapter, network interface card, PCMCIA network card, card bus network adapter, wireless network adapter, USB network adapter, modem or another device suitable for interfacing the computing device 500 to a type of network capable of communication and performing the operations described herein. Moreover, the computing device 500 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 500 can run an operating system 516, such as versions of the Microsoft® Windows® operating systems, the different releases of the Unix and Linux operating systems, a version of the MacOS® for Macintosh computers, the iOS for Apple® iPhone® and iPad® devices, an embedded operating system, a real-time operating system, an open source operating system, a proprietary operating system, an operating systems for mobile computing devices, or another operating system capable of running on the computing device and performing the operations described herein. In exemplary embodiments, the operating system 516 can be run in native mode or emulated mode. In an exemplary embodiment, the operating system 516 can be run on one or more cloud machine instances.

The description is presented to enable a person skilled in the art to create and use a computer system configuration and related method and systems for automatic power source charging and swapping for an AV. Various modifications to the example embodiments will be readily apparent to those skilled in the art, and the generic principles defined herein may be applied to other embodiments and applications without departing from the spirit and scope of the present disclosure. Moreover, in the following description, numerous details are set forth for the purpose of explanation. However, one of ordinary skill in the art will realize that embodiments of the present disclosure may be practiced without the use of these specific details. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further still, other aspects, functions and advantages are also within the scope of the present disclosure.

Exemplary flowcharts have been provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments but rather should be limited only by the spirit and scope of the following claims.

What is claimed is:

1. A system for swapping a power source for an autonomous vehicle (AV), the system comprising:
an AV configured to autonomously complete tasks, the AV being powered by a first power source;
a power source repository storing one or more second power sources and including a power source swapping unit to facilitate autonomous power source swapping for the AV;
a first computing device configured to:
determine whether a first power source of the AV has sufficient power to complete a task assigned to the AV;
direct the AV to a location of the power source repository in response to determining the current power source has insufficient power to complete the assigned task;
positions the AV proximate the power source swapping unit of the power source repository, the AV interacting with the power source swapping unit to enable removal of the first power source from the AV and installation of the second power source into the AV.

2. The system of claim 1, wherein the assigned task includes at least one of scanning inventory, delivering an item from a source location to a destination location, returning an item from a destination location to a source location, monitoring tasks, cleaning tasks, maintenance tasks, auditing tasks and security tasks.

3. The system of claim 1, wherein the first power source comprises at least one of a battery and a fuel cell.

4. The system of claim 1, wherein the AV comprises at least one of an unmanned aerial vehicle (UAV) or an autonomous ground vehicle (AGV).

5. The system of claim 4, wherein a weight of the AV AGV positioning proximate the power source swapping unit causes the first power source to be removed and the second power source to be installed.

6. The system of claim 4, wherein removal of the first power source from the AV and installation of the second power source into the AV comprises at least one of:
positioning the AV on top of the second power source, causing the first power source to be ejected and the second power source to be inserted;
positioning the AV on a dispenser platform of the power source swapping unit wherein the first power source is removed from the AV and wherein the second power source is installed from a cartridge of the power source swapping unit;
positioning the AV adjacent the power source swapping unit, wherein a mechanical arm of the power source swapping unit removes the first power source from the AV and installs the second power source in the AV.

7. The system of claim 1, wherein the AV further includes at least one accessory, the accessory comprising at least one of a camera, a sensor, and a scanner.

8. A computer-implemented method for swapping power sources for an Autonomous Vehicle (AV), the method comprising:
determining whether current first power source installed in an AV has sufficient power to complete a task assigned to the AV;
in response to determining the first power source has insufficient power to complete the assigned task, directing the AV to a location of a power source repository;
positioning the AV proximate to a power source swapping unit of the power source repository;
removing of the first power source from the AV; and
installing a second power source stored at the power source repository into the AV.

9. The method of claim 8, wherein the assigned task includes at least one of scanning inventory, delivering an item from a source location to a destination location, returning an item from a destination location to a source location, monitoring tasks, auditing tasks and security tasks.

10. The method of claim 9, wherein the first power source comprises at least one of a battery and a fuel cell.

11. The method of claim 8, wherein the AV comprises at least one of an unmanned aerial vehicle (UAV) or an autonomous ground vehicle (AGV).

12. The method of claim 11, wherein detection a weight of the AV proximate to the power source swapping unit causes the first power source to be removed and the second power source to be installed.

13. The method of claim 9, wherein removal of the first power source from the AV and installation of the second power source into the AV comprises at least one of:
positioning the AV on top of the second power source, causing the first power source to be ejected and the second power source to be inserted;
positioning the AV on a dispenser platform of the power source swapping unit wherein the first power source is removed from the AV and wherein the second power source is installed from a cartridge of the power source swapping unit;
positioning the AV adjacent the power source swapping unit, wherein a mechanical arm of the power source swapping unit removes the first power source from the AV and installs the second power source in the AV.

14. The method of claim 9, wherein the AV further includes at least one accessory, the accessory comprising at least one of a camera, a sensor, and a scanner.

15. A non-transitory machine-readable medium storing instructions executable by a computing device, wherein execution of the instructions causes the computing device to implement a method for swapping power sources for an Autonomous Vehicle (AV), the method comprising:
determining whether current first power source installed in an AV has sufficient power to complete a task assigned to the AV;
in response to determining the first power source has insufficient power to complete the assigned task, directing the AV to a location of a power source repository;
positioning the AV proximate to a power source swapping unit of the power source repository;
removing of the first power source from the AV; and
installing a second power source stored at the power source repository into the AV.

16. The non-transitory machine-readable medium of claim 15, further comprising instructions wherein the assigned task includes at least one of scanning inventory, delivering an item from a source location to a destination location, returning an item from a destination location to a source location, monitoring tasks, auditing tasks and security tasks.

17. The non-transitory machine-readable medium of claim 15, further comprising instructions wherein the power source comprises at least one of a battery and a fuel cell.

18. The non-transitory machine-readable medium of claim 15, further comprising instructions wherein the AV comprises at least one of an unmanned aerial vehicle (UAV) or an autonomous ground vehicle (AGV).

19. The non-transitory machine-readable medium of claim 18 further comprising instructions wherein detection of a weight of the AV proximate to the replacement power source causes the current power source to be removed and the replacement power source to be installed.

20. The non-transitory machine-readable medium of claim 15 further comprising instructions wherein the removal of the current power source from the AV and the installation of the selected replacement power source into the AV comprises at least one of:
positioning the AV on top of the second power source, causing the first power source to be ejected and the second power source to be inserted;
positioning the AV on a dispenser platform of the power source swapping unit wherein the first power source is removed from the AV and wherein the second power source is installed from a cartridge of the power source swapping unit;
positioning the AV adjacent the power source swapping unit, wherein a mechanical arm of the power source swapping unit removes the first power source from the AV and installs the second power source in the AV.
